(19) United States
(12) Patent Application Publication
(10) Pub. No.: US 2010/0071518 A1
(43) Pub. Date: Mar. 25, 2010

(54) Key ring spreader

(76) Inventor: Margaret Marie Stinson, Canton, MI (US)

Correspondence Address: HARSHAW RESEARCH, INC., 210 W. TECUMSEH STREET, OTTAWA, KS, 66067, US

(21) Appl. No.: 12/380,809

(22) Filed: May 28, 2009

Related U.S. Application Data
(63) Continuation-in-part of application No. 12/069,972, filed on Feb. 15, 2008, now abandoned.

(51) Int. Cl. B25B 27/30

(52) U.S. Cl. 81/485; 29/239

(57) ABSTRACT

A key ring spreader includes a plate having a thin gauge material thickness and generally flat configuration. The plate defines a hole adjacent an end of the plate that is configured to receive a free end of a key ring. The plate may be slid between the split rings of a key ring and twisted so as to separate the split rings sufficiently to insert or remove keys therefrom with ease.

### CROSS-REFERENCE TO RELATED APPLICATIONS

This application is a continuation-in-part of U.S. patent application Ser. No. 12/069,972 filed Feb. 15, 2008 entitled KEY RING SPREADER which claimed priority from U.S. Provisional Patent Application Ser. No. 60/997,731 filed Oct. 5, 2007, specification in which are incorporated herein by reference.

### BACKGROUND OF THE INVENTION

This invention relates generally to ring accessories and, more particularly, to a key ring spreader that may be used to spread the two rings of a traditional key ring.

In the past, a user of a key ring was typically required to use his fingers and fingernails to pry apart the two rings of a key ring in order to insert keys onto the ring. This process of separating the rings may be painful and difficult and may occur every time an additional key is desired to be inserted onto the key ring.

Various devices have been proposed in the art for separating the rings of a key ring. Although assumably effective for their intended purposes, the existing products and proposals do not provide a flexible yet durable device that is useful to separate the rings of a key ring and selectively removable therefrom.

Therefore, it would be desirable to have a key ring spreader that may be used to separate the rings of a key ring, is flexible, and that may be selectively remain on a key ring or removed therefrom.

### SUMMARY OF THE INVENTION

A key ring spreader according to a preferred embodiment includes a plate having a thin gauge material thickness and generally flat configuration. The plate defines a hole adjacent an end of the plate that is configured to receive a free end of a key ring. The plate may be slid between the split rings of a key ring and twisted so as to separate the split rings sufficiently to insert or remove keys therefrom with ease.

Therefore, a general object of this invention is to provide a key ring spreader that may be slid between two rings of a key ring and twisted to separate the rings such that a key or keys may be easily inserted onto the key ring.

Another object of this invention is to provide a key ring spreader, as aforesaid, that reduces damage to a user's fingers and fingernails.

Still another object of this invention is to provide a key ring spreader, as aforesaid, having treated edges to minimize sharpness.

Yet another object of this invention is to provide a key ring spreader, as aforesaid, that is small, portable, and flexible.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a front view of a key ring spreader according to a preferred embodiment of the present invention; and

FIG. 2 is top view of the key ring spreader as in FIG. 1.

### DESCRIPTION OF THE PREFERRED EMBODIMENT

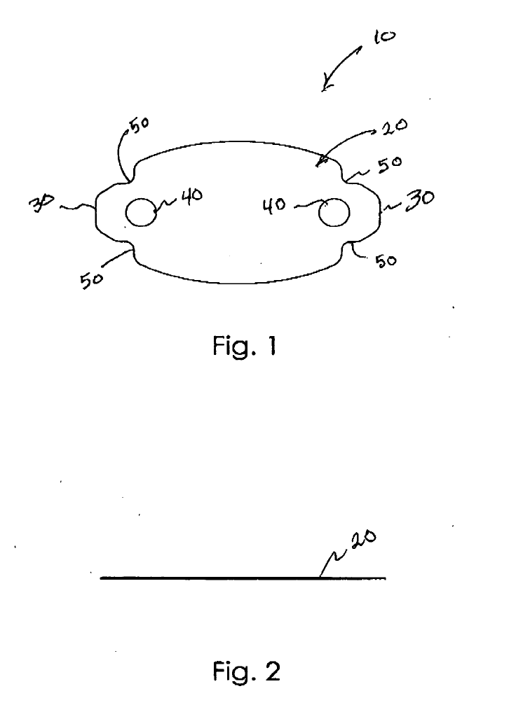

A key ring spreader 10 according to a preferred embodiment of the present invention will now be described with reference to FIGS. 1 and 2 of the accompanying drawings. More particularly, the key ring spreader 10 includes a plate 20 constructed of a thin gauge material such as 0.010 gauge spring steel. The spring steel construction provides flexibility to the plate 20 in use. Preferably, the plate 20 includes a generally oval configuration having planar front and back sides. The plate 20 presents laterally opposed ends 30 with top and bottom edges connecting the ends. The plate 20 defines spaced apart holes 40, each hole having a diameter of 3/16″ and positioned adjacent a respective plate end. It is understood that each hole includes a diameter that can receive a free end of a key ring therethrough. Peripheral edges of the plate 20 further define a pair of notches 50 positioned on opposing sides of each hole 40, each notch preferably having a radius of 0.0125″.

The thin peripheral edges undergo a passivation and corn meal tumbling procedure to radius the thin edges and prevent any sharpness in use.

In use, the key ring spreader 10 may be used to split the coils of a split ring type key holder. The key ring spreader 10 is preferably held between a user's thumb and forefinger and slid in between the two rings of a key ring and then twisted so as to leverage the rings into a split configuration. Accordingly, keys may be inserted onto the ring or removed therefrom with ease.

It is understood that while certain forms of this invention have been illustrated and described, it is not limited thereto except insofar as such limitations are included in the following claims and allowable functional equivalents thereof.

What is claimed is:

1. A key ring spreader for use with a key ring having first and second interconnected rings, said key ring spreader comprising:
a plate having a thin gauge material thickness and generally flat configuration;
said plate defining a hole configured for selectively receiving a free end of one said ring.

2. The key ring spreader as in claim 1, wherein said plate includes another hole separate from said hole.

3. The key ring spreader as in claim 2, wherein said plate includes a length dimension that is about twice as long as a width dimension.

4. The key ring spreader as in claim 3, wherein said plate includes a generally oval configuration.

5. The key ring spreader as in claim 4, wherein said plate defines a pair of notches adjacent respective holes.

6. The key ring spreader as in claim 2, wherein said hole and said another hole are positioned adjacent laterally opposed plate ends.
